(19) United States
(12) Patent Application Publication
(10) Pub. No.: US 2010/0125531 A1
(43) Pub. Date: May 20, 2010

(54) SYSTEM AND METHOD FOR THE AUTOMATED FILTERING OF REVIEWS FOR MARKETABILITY

(75) Inventor: VICTOR K. WONG, New Haven, CT (US)

Correspondence Address: OHLANDT, GREELEY, RUGGIERO & PERLE, LLP, ONE LANDMARK SQUARE, 10TH FLOOR, STAMFORD, CT, 06901, US

(73) Assignee: PaperG, Inc.

(21) Appl. No.: 12/622,384

(22) Filed: Nov. 19, 2009

Related U.S. Application Data
(60) Provisional application No. 61/116,123, filed on Nov. 19, 2008.
(60) Provisional application No. 61/116,117, filed on Nov. 19, 2008.

(51) Int. Cl. G06Q 10/00; G06Q 90/00

(52) U.S. Cl. 705/347; 705/500

(57) ABSTRACT

A method for generating marketing materials using filtered reviews including the step of receiving a set of reviews for a business and filtering the reviews into a set of reviews containing a quantitative rating and a set of reviews without such a rating. The method further includes determining a set of reviews containing quantitative ratings that exceed a quantitative threshold. The method further semantically filters these reviews along with the set of reviews without a quantitative rating to generate a set of reviews that exceed a semantic threshold of satisfaction for the business. The method then ranks these reviews based on quantitative rating, and further ranks the reviews based on semantic analysis. Reviews include professional reviews, user-generated reviews, aggregate ratings, commentary, rankings, etc. Marketing materials include print advertisements, online advertisements, brochures, pamphlets, websites, flyers, videos, etc.

This application claims the benefit of U.S. Provisional Patent Application Ser. No. 61/116,117 and U.S. Provisional Patent Application Ser. No. 61/116,123, both filed on Nov. 19, 2008, the contents of which are incorporated by reference herein.

### BACKGROUND OF THE INVENTION

1. Field of the Invention

The present disclosure relates to a system and method for filtering professional reviews, user-generated reviews, aggregate ratings, commentary, rankings, etc. for use in generating print advertisements, online advertisements, brochures, pamphlets, websites, flyers, videos, etc. (“Marketing Materials”). More particularly, the present disclosure relates to a system and method for filtering a set of reviews using pre-defined criteria to identify those that portray the business most favorably. Among other uses, the system may be used to automate design aspects of Marketing Materials.

2. Description of Related Art

As the Internet continues to develop, businesses are seeking opportunities to use information available on the Internet for use in Marketing Materials. Many websites make available professional reviews, user-generated reviews, aggregate ratings, commentary, rankings, etc. (“Reviews”). For example, user-generated reviews may include reviews, ratings, and other commentary posted by patrons and clients of such business to share experiences about shopping, dining, movies, concerts, hotels, or vacation spots. Such Reviews can take the form of text, images, audio, or video.

While many websites make available such Reviews, there does not exist a system or methodology to search disparate sources that contain Reviews and generate Marketing Materials using Reviews that are determined to portray the business most favorably (“Selected Marketable Reviews”), for example the best or most positive Reviews. Such disparate sources may include websites, databases, and structured data feeds, which may be internal or maintained by third parties (“Content Sources”).

Accordingly, there is a need for a system and a software system that would search disparate Content Sources containing Reviews and filter such Reviews using predefined filtering criteria to quantitatively and qualitatively identify Selected Marketable Reviews for the purpose of helping a user, such as a advertisement representative of a media company or a business owner, generate Marketing Materials.

### SUMMARY OF THE DISCLOSURE

The present disclosure provides for a software system and method for automatically generating Marketing Materials for a business by receiving identifying information about a business from a user. The software system automatically searches a plurality of Content Sources for Reviews related to a business, and filters the Reviews based on pre-defined criteria to generate Marketing Materials.

The present disclosure further provides for a method that uses identifying information from the user to search databases to generate a list of Content Sources that may contain Reviews related to the business.

The present disclosure also provides for a method that uses the identifying information and searches Content Sources for Reviews. The Reviews are then filtered using pre-defined criteria to identify Selected Marketable Reviews for use in Marketing Materials.

These and other and further features and advantages are provided by a method that a) receiving a set of reviews of a topic; b) filtering reviews in the set of reviews based upon filtering criteria to generate a set of filtered reviews; and c) generating a report based upon filtered reviews in the set of filtered reviews.

These and other objects and advantages of the present invention are provided through its ability to identify Selected Marketable Reviews. This is achieved by receiving a set of Reviews of a business and filtering the Reviews into a set of Reviews containing a quantitative rating and a set of Reviews without such a rating. The method further filters the Reviews containing a quantitative rating to include only those with ratings that exceed a quantitative threshold. The method further semantically filters these Reviews along with the set of Reviews without a quantitative rating to generate a set of Reviews that exceed a semantic threshold of satisfaction for the business. The method then ranks these Reviews based on quantitative rating, and further ranks the Reviews based on semantic analysis.

A system including a processor that performs a method that includes: receiving a set of Reviews of a business and filtering the Reviews into a set of Reviews containing a quantitative rating and a set of Reviews without such a rating. The method further filters the Reviews containing a quantitative rating to include only those with ratings that exceed a quantitative threshold. The method further semantically filters these Reviews along with the set of Reviews without a quantitative rating to generate a set of Reviews that exceed a semantic threshold of satisfaction for the business. The method then ranks these Reviews based on quantitative rating, and further ranks the Reviews based on semantic analysis.

A computer readable storage medium having stored therein instructions that are executable by a processor for performing a method includes: receiving a set of Reviews of a business and filtering the Reviews into a set of Reviews containing a quantitative rating and a set of Reviews without such a rating. The method further filters the Reviews containing a quantitative rating to include only those with ratings that exceed a quantitative threshold. The method further semantically filters these Reviews along with the set of Reviews without a quantitative rating to generate a set of Reviews that exceed a semantic threshold of satisfaction for the business. The method then ranks these Reviews based on quantitative rating, and further ranks the Reviews based on semantic analysis.

### BRIEF DESCRIPTION OF THE DRAWINGS

The foregoing will be more apparent from the following detailed explanation of the preferred embodiments of the invention in connection with the accompanying drawings.

FIG. 1 illustrates a hardware and software system for carrying out the method of the present disclosure;

FIG. 2 illustrates exemplary methods of obtaining a set of Reviews;

FIG. 3 illustrates a flowchart illustrating the method of filtering using predefined filtering criteria to quantitatively and qualitatively identify Selected Marketable Reviews for the purpose of helping a user generate Marketing Materials;

FIG. 4 illustrates a Review and an excerpt of a Review, according the method of the present invention;

FIG. 5 illustrates Marketing Materials in the form of an advertisement that incorporates an excerpt of a Review and a quantitative rating, according to the method of the present invention; and

FIG. 6 illustrates Marketing Materials in the form of a website that is generated using the method of the present invention.

### DETAILED DESCRIPTION OF THE INVENTION

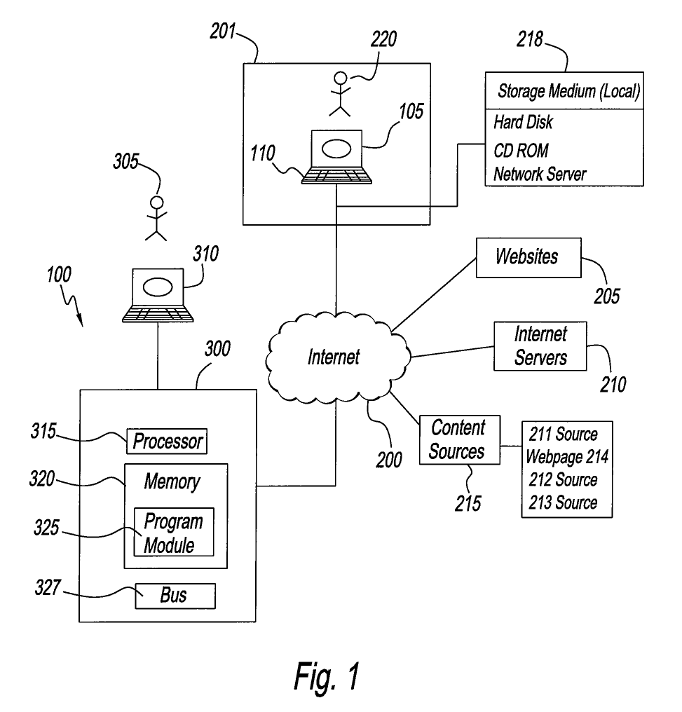

Referring to the drawings and in particular to FIG. 1, a block diagram of the system of the present disclosure is shown and generally referenced by reference numeral 100. System 100 includes a computer system 300. An operator 305 is able to program computer 300. Computer system 300 includes a user interface 310, a processor 315, memory 320, and a bus 327. Computer 300 may be implemented on a general-purpose microcomputer. Processor 315 is configured of logic circuitry that responds to and executes instructions. Memory 320 stores data and instructions for controlling the operation of processor 315. Memory 320 may be implemented in a random access memory (RAM), a hard drive, a read only memory (ROM), or a combination thereof. One of the components of memory 320 is a program module 325.

Program module 325 contains instructions for controlling processor 315 to execute the methods described herein. For example, as a result of execution of program module 325, processor 315 is able to receive instructions/input from a user 220, search computer network 200 (e.g. Internet) using input and retrieve a list of Content Sources from computer network 200 that is used to generate a report such as an advertisement. The term “module” is used herein to denote a functional operation that may be embodied either as a stand-alone component or as an integrated configuration of a plurality of sub-ordinate components. Thus, program module 325 may be implemented as a single module or as a plurality of modules that operate in cooperation with one another. Moreover, although program module 325 is described herein as being installed in memory 320, and therefore being implemented in software, it could be implemented in any hardware (e.g., electronic circuitry), firmware, software, or a combination thereof.

User 220 has access to system 100 via a computer network 200, as shown, or from a server. User 220 may be a sales person at a media company, an employee at a business 201, a business owner, or other person who may be otherwise charged with preparing Marketing Materials for business 201, such as a graphic designer. User 220 accesses system 100 using a computer 105 having a user interface 110. Computer 105 is coupled to and has access to system 100 via a network 200. Computer 105 also has associated therewith local storage mediums 218.

Network 200 provides access to websites 205, internet servers 210 and various Content Sources 215, for example. Computer 105 includes an input device such as a keyboard or speech recognition subsystem for enabling a user to communicate information and command selections through network 200 to processor 315. User interface 110 also includes an output device such as a display or a printer. A cursor control such as a mouse, track-ball, or joy stick, allows the user to manipulate a cursor on the display for communicating additional information and command selections through network 200 to processor 315. User interface may also be a personal digital assistant (PDA), or the like.

User interface 110 and computer 105 are able to access program module 325 of computer system 300 from network 200. Operator 305 makes program module 325 available to user 220 via network 200 from, for example, a website.

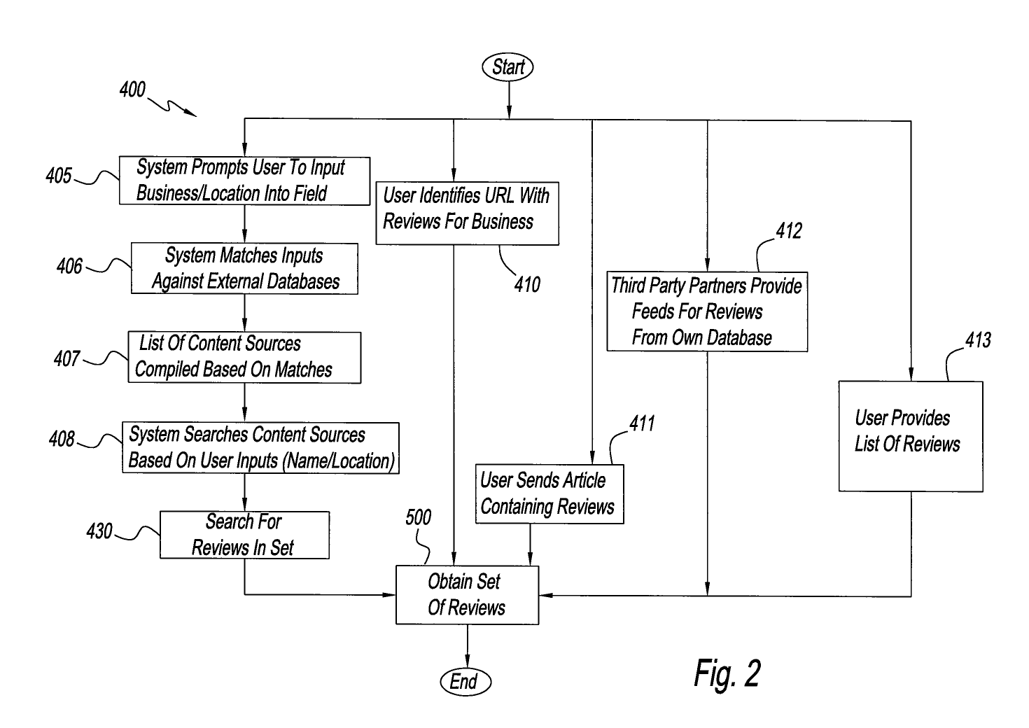

Referring to FIG. 2, there are numerous ways that user 201 can obtain a set of Reviews to be reviewed by method of present invention. FIG. 2 provides exemplary methods by which user 201 may obtain set of Reviews to be reviewed in present application, although other methods may be used to obtain set of Reviews. Referring again to FIG. 2, a method is shown and referenced by reference numeral 400.

In step 405, after the start, system 100 prompts user 220 to enter information related to business 201 into a field on a screen, such as a business name and/or location. The location of business can be a segment of a business location, such as a street address, a postal code, a state/region, or any combination thereof (“Location Input”). Such information is preferably entered by user 220 via user interface 110.

In step 406, processor 315 searches various sources that contain standardized business names and locations. Step 406, process searches using information provided by user 220 in step 405. Step 406 results in a standardized business name and location, or if none is found, a descriptor of such business that was provided by user in step 405.

In step 407, system 100 searches network 200 and compiles a list of Content Sources using standardized name and location.

Content Sources are preferably one or a plurality of websites identified by one or a plurality Uniform Resource Locators (URLs) that may include Reviews.

In step 408, system 100 searches Content Sources compiled in step 407 for Reviews using descriptor and forwards Reviews to system 100 in step 500.

Alternatively, in step 410, user 201 can provide a URL to a webpage containing Reviews of a business, and a set of Reviews can be extracted from such webpage for use in step 500.

Alternatively, in step 411, user 201 can provide an offline article containing one or more Reviews of a business, which can be transcribed for use in step 500.

Alternatively, in step 412, third parties or partners can provide structured data feeds from which Reviews can be extracted for use in step 500.

Alternatively, in step 413, user 220 directly provides a list of Reviews for use in step 500.

Method 400 provides examples of how Reviews for a business may be obtained and is not in intended in any way to limit the scope of the method of FIG. 2 of the present disclosure.

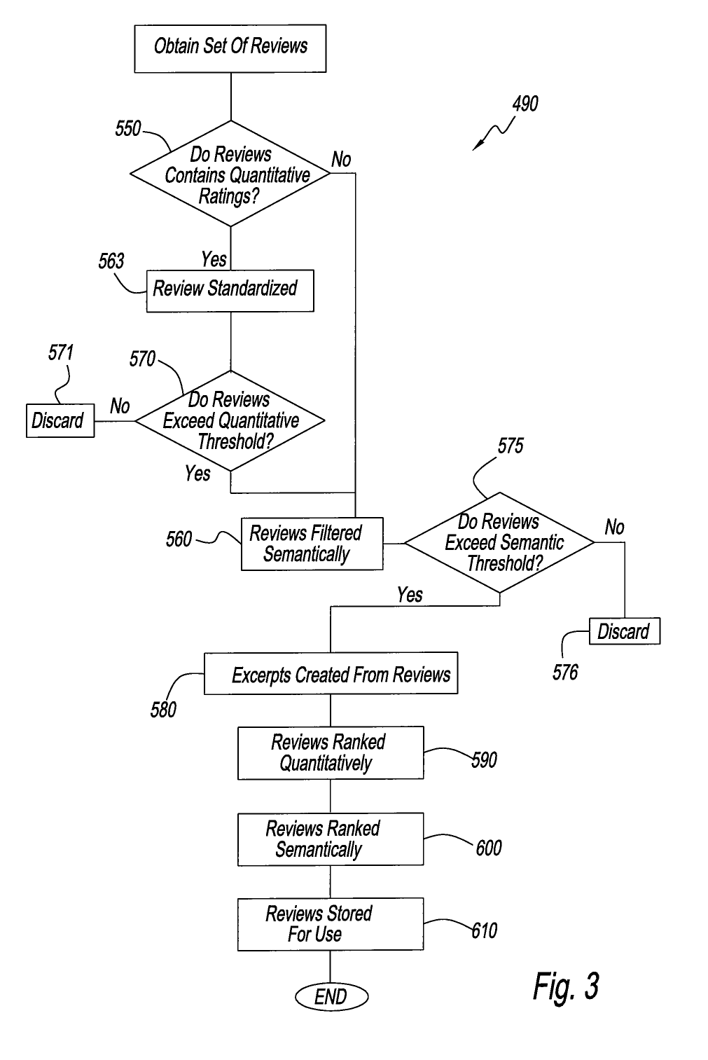

Referring to FIG. 3, in step 550, system 100 obtains a set of Reviews that are to be filtered based on predefined criteria created by operator 305.

In step 550, processor 315 filters Reviews that contain a quantitative rating. Quantitative ratings may be based on a symbol, such as a star, or a numerical rating. If a review is found to contain a quantitative rating, such rating is standardized in step 563 to comply with a predetermined scale. For example, all quantitative ratings may be converted to a standardized 5-star scale for ease of comparison.

For example, a rating on a 4 star rating scale can be converted to a standardized 5-star scale by multiplying the rating by 5/4. As another example, a numerical rating based on a rating scale of 100 can be converted to a standardized 5-star scale by dividing the numerical rating by 20.

In step 570, only Reviews containing a standardized rating exceeding a minimum quantitative threshold are accepted. For example, the minimum quantitative threshold could be 4 stars on a 5-star scale. If a review contains a rating not exceeding the threshold, it is discarded in step 571.

Reviews from step 570 that exceed the quantitative threshold, as well as Reviews from step 550 that do not have quantitative ratings, are both filtered semantically in step 560.

In step 560, processor 315 filters Reviews semantically by searching for particular keywords, phrases, or sentiments—both positive and negative—within the content of the Review. For example, step 560 may search for positive words or phrases such as “best,” “excellent,” or “best of my life” and/or negative words or phrases such as “rodent,” “worst,” or “bland.” Step 560 may also use other semantic techniques to analyze the content of the Reviews and identify Selected Marketable Reviews for inclusion in Marketing Materials.

Processor 315 analyzes these keywords, phrases, and sentiments and in step 575 determines whether the review exceeds a pre-defined semantic threshold to qualify as Selected Marketable Reviews. An example where a Review may not exceed the semantic threshold is if it contains any negative words or phrases or is otherwise deemed unmarketable. Reviews that exceed the semantic threshold are saved and those that do not are discarded in step 576.

In step 580, excerpts are created from the Reviews that exceed the pre-defined semantic threshold from step 575. For example, processor 315 can create an excerpt for a Review based on certain predefined keywords and punctuation marks surrounding the keyword. The technique of extracting these excerpts aims to find a portion of the Review that portrays the business most favorably.

In step 590, processor 315 ranks Reviews. For example, Reviews with “5” ratings are ranked together ahead of Reviews with “4” ratings. Reviews without a quantitative rating are ranked together after Reviews with the lowest quantitative ranking.

In step 600, within a grouping of similarly ranked Reviews, Reviews are further ranked using semantic analysis and/or based on the presence or absence of certain keywords. In similar quantitative groupings, Reviews with keywords more conducive to being Selected Marketable Reviews are ranked higher than those without. For example, among Reviews containing a 5-star rating, those containing the phrase “best meal” would be ranked ahead of those containing the phrase “good meal.”

In step 610, a ranked set of Selected Marketable Reviews from the preceding steps is stored or catalogued according to their ranking for use in Marketing Materials.

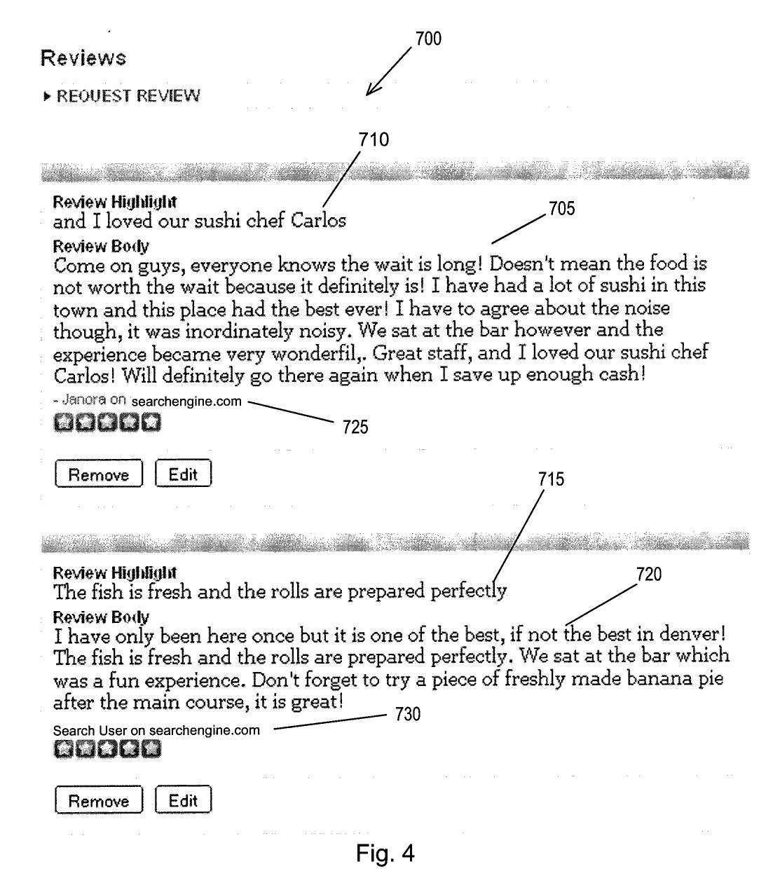

Referring to FIG. 4, an illustration of a screen shot 700 containing Reviews 705 and 720 is shown. Excerpts 710 and 715 are generated by processor 315 by identifying keywords and punctuation. Links 725 and 730 provide links to the sources of the Reviews.

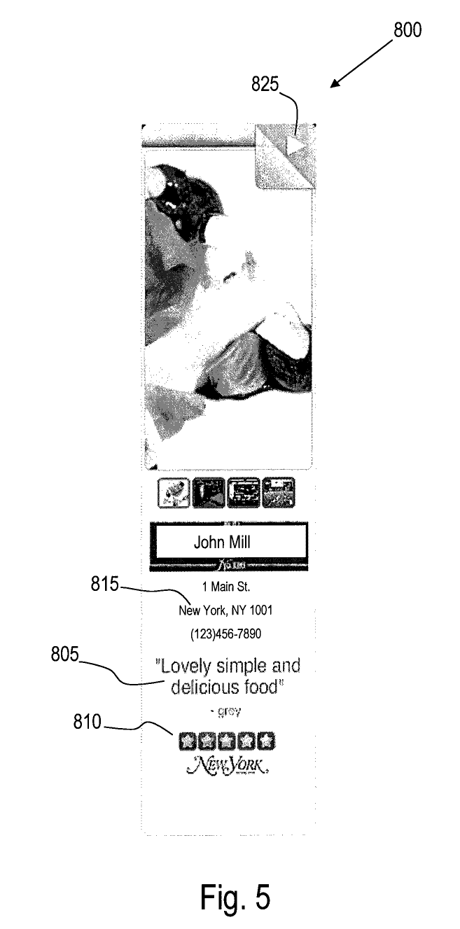

Referring to FIG. 5, a sample advertisement for a restaurant is illustrated by reference numeral 800. Advertisement 800 includes a Review excerpt 805, the name of the individual providing the Review in excerpt 805, a rating 810, and business information 815. Advertisement 800 also provides additional information using link 825.

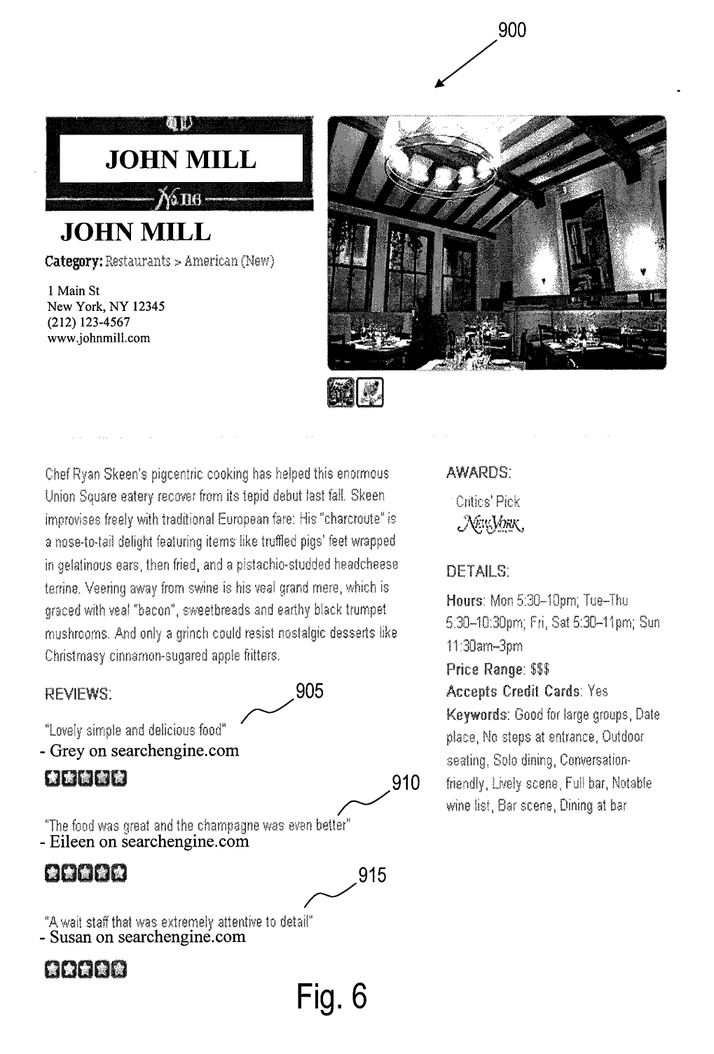

FIG. 6 illustrates an example of a website 900 generated by method 490 of the present invention. Website 900 contains Review excerpts 905, 910, and 915. Website 900 also provides business details related to the restaurant and awards won by the restaurant. While method 490 is used to generate advertisement 800 and website 900, other Marketing Materials in general could also be created using the method of the present disclosure.

The present invention has been described with particular reference to the preferred embodiments. It should be understood that the foregoing descriptions and examples are only illustrative of the present invention. Various alternatives and modifications thereof can be devised by those skilled in the art without departing from the spirit and scope of the present invention. Accordingly, the present invention is intended to embrace all such alternatives, modifications, and variations that fall within the scope of the appended claims.

I claim:

1. A method comprising:
a) receiving a set of reviews of a topic;
b) filtering reviews in said set of reviews based upon filtering criteria to generate a set of filtered reviews; and
c) generating a report based upon filtered reviews in said set of filtered reviews.

2. The method of claim 1, wherein said filtering comprises semantic filtering and/or quantitative filtering.

3. The method of claim 1, wherein said filtering is semantic filtering and said filtering criteria comprises filtering based on keywords, phrases, and/or sentiments.

4. The method of claim 2, wherein said semantic filtering comprises filtering reviews exceeding a pre-defined semantic threshold.

5. The method of claim 1, wherein said filtering is quantitative filtering and said filtering criteria comprises identifying reviews exceeding a pre-defined quantitative threshold.

6. The method of claim 5, wherein said reviews are those with quantitative ratings.

7. The method of claim 6, wherein said quantitative rating is one of a numerical rating or a symbol indicative of a numerical rating.

8. The method of claim 1, further comprising prioritizing and/or ranking said filtered reviews based upon said filtering criteria.

9. The method of claim 8, wherein said filtered reviews include those having undergone semantic filtering.

10. The method of claim 9, wherein filtering criteria for those reviews having undergone semantic filtering comprises filtering based on keywords, phrases, and/or sentiments.

11. The method of claim 8, wherein said filtered reviews include those having undergone quantitative filtering.

12. The method of claim 11, wherein filtering criteria for those reviews having undergone quantitative filtering comprises comparing the numerical ratings of the reviews based on a standardized scale.

13. The method of claim 12, wherein said standardized scale comprises converting different rating scales to a uniform scale for ease of comparison.

14. The method of claim 1, further comprising generating an excerpt of reviews in said set of filtered reviews.

15. The method of claim 14, wherein said generating an excerpt aims to find a portion of the review that portrays the business most favorably.

16. The method of claim 1, wherein said reviews in said set of reviews comprise professional reviews, user-generated reviews, aggregate ratings, commentary, and rankings.

17. The method of claim 1, wherein said topic is selected from the group consisting of a business, an organization, a product, a creative work, a service, a person or an event.

18. The method of claim 1, wherein said report comprises marketing materials concerning said business.

19. The method of claim 18, wherein said marketing materials comprise a print advertisement, a online advertisement, a brochure, a pamphlet, a website, a flyer or a video.

20. A system comprising a processor that performs a method that includes:
a) receiving a set of reviews of a topic;
b) filtering reviews in said set of reviews based upon filtering criteria to generate a set of filtered reviews; and
c) generating a report based upon filtered reviews in said set of filtered reviews.

21. A computer readable storage medium having stored therein instructions that are executable by a processor for performing a method comprising.
a) receiving a set of reviews of a topic;
b) filtering reviews in said set of reviews based upon filtering criteria to generate a set of filtered reviews; and
c) generating a report based upon filtered reviews in said set of filtered reviews.
